(19) United States
(12) Patent Application Publication
(10) Pub. No.: US 2008/0222121 A1
(43) Pub. Date: Sep. 11, 2008

(54) System for Adaptively Querying a Data Storage Repository

(76) Inventors: Wolfgang Wiessler, W. Chester, PA (US); Debarshi Datta, Old Bridge, NJ (US); Steven F. Owens, Denville, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/756,886

(22) Filed: Jun. 1, 2007

Related U.S. Application Data
(60) Provisional application No. 60/803,750, filed on Jun. 2, 2006.

(51) Int. Cl. G06F 17/30; G06F 7/10

(52) U.S. Cl. 707/4; 707/E17.014

(57) ABSTRACT

An input processor receives a plurality of different first query messages in a corresponding plurality of different formats. A repository includes stored data elements in a first storage data structure. An intermediary processor automatically: parses the plurality of first query messages to identify requested data elements; maps the identified requested data elements to stored data elements in the first storage data structure of the repository; generates a plurality of second query messages in a format compatible with the repository for acquiring the stored data elements; acquires the stored data elements from the repository using the generated plurality of second query messages; and processes the acquired stored data elements in the plurality of second query messages for output in a format compatible with the corresponding plurality of different formats of the first query messages.

This is a non-provisional application of provisional applications Ser. No. 60/803,750 by S. F. Owens et al. filed Jun. 2, 2006.

### FIELD OF THE INVENTION

The present invention relates to data storage repository systems, and in particular to systems for querying a data storage repository.

### BACKGROUND OF THE INVENTION

The number of sources or repositories of data are increasing. These sources may be electronic instruments generating real time data, computer systems gathering and storing data, or remote systems returning data in response to requests from a user. It is often required to integrate and/or combine data retrieved from the different data sources. Typically each data source is developed and/or maintained independently from the others, possibly by different vendors. This results in different methods for querying the data source, and different formats for both the query to the data source and the data retrieved from the data source. Further, new data sources frequently become available, and access to these data sources is desired by a user.

For example, in medical content management systems, diverse sources of medical data are available, and new ones become available. Data from the diverse sources are combined to derive useful information. For example, in the diagnosis and treatment of cancer, metabolic information derived from PET or SPECT studies may be correlated with the anatomical information derived from high resolution CT studies. Further data may be available from molecular imaging which is also combined with the data described above. Each additional source of data requires that the querying system for accessing this data, and the formats for communicating queries and data, be adapted to the new sources of data.

The different medical data systems, such as picture archiving and communication systems (PACs), radiology information systems (RIS), laboratory information systems (LISs) and other department information systems, are not individually configured to accommodate the diversity of data which is available now and will be available in the future. This is because current data storage repository query systems use a fixed data schema, and different data storage repositories use different fixed query systems. Further, different applications use different query schemas and data formats for querying data storage repositories. A system for querying a data storage repository which is flexible and dynamic in nature is desirable.

### BRIEF SUMMARY OF THE INVENTION

In accordance with principles of the present invention, a system adaptively queries a data storage repository. An input processor receives a plurality of different first query messages in a corresponding plurality of different formats. A repository includes stored data elements in a first storage data structure. An intermediary processor automatically: parses the plurality of first query messages to identify requested data elements; maps the identified requested data elements to stored data elements in the first storage data structure of the repository; generates a plurality of second query messages in a format compatible with the repository for acquiring the stored data elements; acquires the stored data elements from the repository using the generated plurality of second query messages; and processes the acquired stored data elements in the plurality of second query messages for output in a format compatible with the corresponding plurality of different formats of the first query messages.

Such a system enables different applications, each implementing a different data model, to access the same data stored in the same storage repository. In a special case of this situation, the same application may implement different data models to access the same data. In addition, such a system permits adding a new data type or replacing a data element with a new data element, possibly being stored in a different location or on a different storage repository. Such a system also permits dynamically changing the storage data model, i.e. the model of the data within the storage repository, without affecting the applications. That is, the applications do not need to now how the data is stored on the repository. Similarly, such a system permits dynamically changing of the data storage repository itself. That is, a change may be made in the data storing devices holding the storage data structure. These changes may be made without requiring a change in the executable application or executable procedures implementing either the applications or client, or the data storage repository. This means that no recoding and no retesting of executable application code is necessary to provide the various changes described above.

### BRIEF DESCRIPTION OF THE DRAWING

In the drawing:

FIG. 1 is a block diagram of a system for adaptively querying a data storage repository according to principles of the present invention;

FIG. 2 is a more detailed block diagram illustrating a portion of the system of FIG. 1 according to the present invention;

FIG. 3 is a data relationship diagram illustrating the components of an information model mapper which is a part of the system of FIG. 1 according to principles of the present invention;

FIG. 4 is a flowchart illustrating the operation of a system for adaptively querying a data storage repository according to principles of the present invention; and

FIG. 5 is an example of a core schema,

FIG. 6 is an example of an output schema,

FIG. 7 is an example of a mapping file,

FIG. 8 is an example of a query file, and

FIG. 9 is an example of a output file, which, in combination, are useful in understanding the operation of the system of FIG. 1 according to principles of the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a system for adaptively querying a data storage repository, or other information processing system, for example, in response to user command or input. An executable procedure is a segment of code or machine readable instruction, sub-routine, or other distinct section of code or portion of an executable application for performing one or more particular processes. These processes may Include receiving input data and/or parameters, performing operations on received input data and/or performing functions in response to received input parameters, and providing resulting output data and/or parameters.

A data repository as used herein comprises a source of data records. A data repository may be a one or more storage devices containing the data records and may be located local to or remote from the processor. If located remote from the processor, data may be communicated between the processor and the data repository through a communications channel, such as a dedicated data link, a computer network, i.e. a local area network (LAN) and/or wide area network such as the Internet, or any combinations of such communications channels. A data repository may also be sources of data records which do not include storage devices, such as live feeds, e.g. news feeds, stock tickers or other such real-time data sources. A record as used herein may comprise one or more documents and the term “record” may be used interchangeably with the term “document”.

The World Wide Web Consortium (W3C) has defined a standard called XML schema. An XML schema provides a means for defining the structure, content and semantics of XML documents. An XML schema is used to define a metadata structure. For example, the metadata may define or mirror the structure of a collection of nested tables. The respective tables contain a collection of fields (that cannot be nested). The respective fields contain a collection of data elements.

The term abstraction refers to the practice of reducing or factoring out details so broader, more important concepts, may be concentrated on. The term data abstraction refers to abstraction of the structure and content of data, such as data stored in data repositories, from the meaning of the data itself. For example, a user may be interested in an X-Ray image, but not where data representing that image is stored, how it is stored, or the mechanism required to access and retrieve that data. A data abstraction layer refers to an executable application, or executable procedure which maintains a data abstraction between a user and the storage of data important to the user. In particular, as used herein, a data abstraction layer is a system for obtaining data from a repository without prior knowledge of the repository structure using predetermined information supporting parsing, analyzing and querying the repository.

The term “Schema” is used herein in different contexts. When it is used in relation to XML (e.g. “XML schema”), a normal XML schema file conforming to the w3c definition is meant. When it is used in relation to a database, the database schema (e.g. tables, rows, fields, or hierarchy, etc.) as part of the real database is meant. When it is used in relation to a term of the data-abstraction layer (e.g. “output schema”), the XML schema file containing the information is meant (described in more detail below). An XML file which describes information used by the data abstraction layer and adheres to one of the data abstraction layer schemas, is referred to as “<data abstraction layer term>” plus “file”, e.g. “Mapping file” (also described in more detail below).

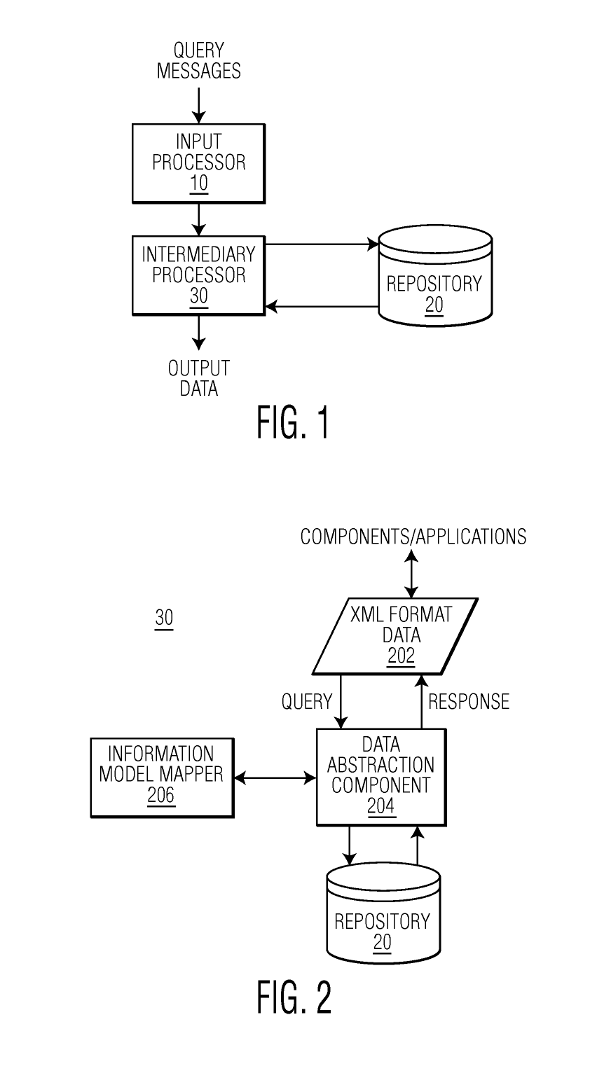

FIG. 1 is a block diagram of a system for adaptively querying a data storage repository according to principles of the present invention. In FIG. 1, an input processor 10 receives a plurality of query messages at an input terminal. An output terminal of the input processor 10 is coupled to a first input terminal of an Intermediary processor 30. A first output terminal of the intermediary processor 30 is coupled to an input terminal of a repository 20. An output terminal of the repository 20 is coupled to a second input terminal of the intermediary processor 30. A second output terminal of the intermediary processor 30 generates output data in response to the received query messages.

In operation, the input processor 10 receives a plurality of different first query messages in a corresponding plurality of different formats. The repository 20 contains stored data elements in a first storage data structure. The input processor 10 sends the plurality of first query messages to the intermediary processor 30 which automatically performs the following activities. It parses the plurality of first query messages to identify requested data elements. It maps the identified requested data elements to stored data elements in the first storage data structure in the repository 20. It generates a plurality of second query messages in a format compatible with the repository 20 for acquiring the stored data elements. The plurality of second query messages are sent to the repository 20. The intermediary processor 30 acquires the stored data elements from the repository 20 using the generated plurality of second query messages. Further, it processes the stored data elements acquired in response to the plurality of second query messages for output in a format compatible with the corresponding plurality of different formats of the first query messages.

More specifically, the input processor 10 receives at least one first query message including a request for information and an instruction determining a data format for providing the information. The instruction is alterable to adaptively change the information and the data format for providing the information. The instruction determining the data format for providing the information may be in a markup language output schema. For example, the markup language output schema may be an extendible markup language (XML) schema. This query message is sent to the intermediary processor 30. The intermediary processor 30 parses the at least one first query message to identify requested data elements. It maps the identified requested data elements to stored data elements in the first storage data structure of the repository 20. It then generates at least one second query message in a format compatible with the repository 20 for acquiring the stored data elements, which is sent to the repository 20. It acquires the stored data elements from the repository 20 using the generated at least one second query message. Further, it processes the stored data elements acquired in response to the at least one second query message for output in a format compatible with the data format determined by the instruction in the at least one first query message.

In the system of FIG. 1, the intermediary processor 30 advantageously automatically performs the activities described above without recompiling or re-testing executable code used in performing said activities. This flexibility is achieved by embodying information related to said activities in files containing data describing details related to performing said activities. More specifically, the system embodies the query specific information in descriptive files (e.g. core schema, extension schema, mapping file, output schema, query file, etc., described below) instead of in the executable code. The data in the descriptive files may be changed, without changing the executable code, to change aspects of data retrieval.

The first query messages comprise files conforming to a query schema and the second query messages comprise queries executable by the repository 20. The first query messages are in a format determined by the query schema. The query schema determines: (a) the query search depth of hierarchical data elements in the repository 20, and/or (b) restrictions on searching the repository 20. The query schema may comprise (a) an SQL compatible query format, and/or (b) an Xquery compatible format.

As described above, the intermediary processor 30 processes stored data elements acquired from the repository 20 for output in a format compatible with the corresponding plurality of different formats of the first query messages. The format compatible with the corresponding plurality of different formats of the first query messages are determined by an output schema. The system of FIG. 1 includes data determining the output schema. The system of FIG. 1 further includes data determining a core schema which indicates data fields accessible in the first storage data structure in the repository 20 of stored data elements. It further includes a mapping schema determining the mapping of the identified requested data elements to the stored data elements in the first storage data structure in the repository 20.

FIG. 2 is a more detailed block diagram of the intermediary processor 30 of the system of FIG. 1 according to the present invention. In FIG. 2, executable applications, or components of executable applications, sometimes called clients, send data representing first query messages 202 in XML format to the intermediary processor 30 via the input processor 10 (FIG. 1). The queries 202 are provided to a data abstraction component 204. The data abstraction layer 204 does not include in its programming any knowledge of the structure or operation of either the executable applications or components, nor of the repository 20. Instead, information relating to the structure and operation of these elements is contained in data stored in the information model mapper 206. The data abstraction component 204 accesses information in the information model mapper 206 to parse the first query messages and to map the data elements identified in the first query messages to stored data elements in the first storage data structure.

The data abstraction component further accesses the information in the information model mapper 206 to generate second query messages in a format compatible with the repository 20 to request the identified stored data elements. The second query messages are in a format executable by the repository 20. For example, in the case of a computer database, the second query messages may be in an SQL compatible query format or an Xquery compatible query format. The second query messages are supplied to the repository 20. In response, the repository 20 returns the requested stored data elements. The data abstraction component 204 acquires the stored data elements from the repository 20 in response to the second query messages. The data abstraction component 204 again accesses information in the information model 206 to process the acquired stored data elements to place them in a format compatible with the corresponding first query received from the input processor 10 (FIG. 1). The reformatted data is returned to the executable application, client or component which requested it.

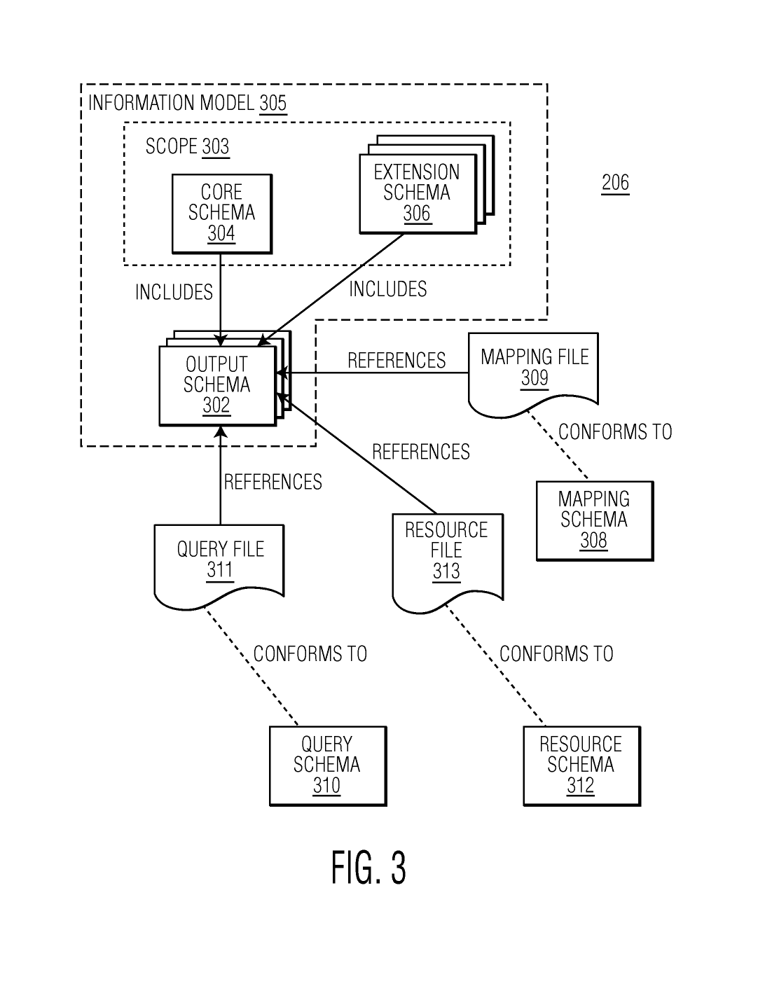

FIG. 3 is a data relationship diagram illustrating components of an information model mapper 206 which is a part of the system of FIG. 1 according to principles of the present invention. In the embodiment illustrated in FIG. 3, the schema are implemented as XML schema, and data is expected in the form of XML files. These data files may be validated by checking it against the XML schema defining its content and structure.

In FIG. 3, the information model mapper 206 includes a core schema 304 and one or more extension schemas 306. The core schema 304 and extension schemas 306 (described in more detail below) define the scope 303 of one application. The scope 303 of an application represents requested data elements which may be used and referenced by other schemas in order to make up the data model. More specifically, the core schema 304 and extension schemas 306 define the data elements which are available to be requested, but do not define any hierarchies. The elements defined in the scope 303 are atomic (i.e. they do not have child elements) and may be used to define levels, but may not function as levels themselves.

The information model mapper 206 further includes one or more output schema 302 (described in more detail below). An output schema 302 specifies the relationship among the available requested data elements defined in the scope 303 of an application (e.g. core schema 304 and extension schemas 306). More specifically, the output schema 302 defines an output hierarchy by specifying levels in the information model. The combination of the scope 303 of an application and one output schema 302 defines the information model 305 for either a whole application, or a part of it (e.g. one client).

A mapping schema 308 (described in more detail below) defines the contents and structure of a mapping file 309. A mapping file 309 specifies the correspondence among data elements defined in the information model 305 and the storage data structure of the repository 20 (FIG. 2). That is, a mapping file 309, constructed in conformance with the mapping schema 308, defines where data elements defined in the information model are located in the repository 20, and how they may be retrieved from the repository 20.

The information model mapper 206 further includes a query schema 310 (described in more detail below). In order to retrieve data from the repository 20, the data abstraction layer 206 processes query data 202 received from the input processor 10 (FIG. 1) in the form of an XML format query file 311. The query schema 310 defines the respective contents and structure of the query files 311 received by the data abstraction component 204. That is, the plurality of first queries submitted by an executable application or component or client are respective query files 311 which conform to the query schema 310.

The data abstraction component 204 further includes a resource schema 312 (described in more detail below). The resource schema 312 defines the content and structure of a resource file 313. The resource file 313 serves as a repository of data specifying external data sources in the repository 20. These data sources may be queried by the data abstraction layer 204 or data may be returned to the requester so that the external data sources may be queried by the requester outside of the data abstraction layer 204. Examples of the schemas and files illustrated in FIG. 3 are given in an Appendix following.

In more detail, a core schema 304 describes the basic elements that an output schema 302 in the same scope 303 may use to build up an output model. The multiple output schemas 302 include the schema data contained in the core schema 304 in order to have access to its elements. In the present embodiment, in which the core schema and output schema are XML schemas, the term ‘includes’ means a textual copying of the contents of the core schema 304 into the multiple output schemas 302. This may be done by placing a textual reference to the core schema 304 in the multiple output schemas 302. The core schema 304 does not define any relation between the provided elements and is not used as a schema for actual XML files. Common data types and element groups for convenient reference may be defined in a core schema 304. Its main use is to unify the declaration of commonly used elements in one scope. The basic structure is:
Inclusion of the general schema
Type definitions
Element definitions
Definition of additional auxiliary elements to simplify common usage (e.g. groups of elements)

A core schema 304 also defines which elements can provide additional external links. An external link is a reference to a resource, defined in the resources file 313 combined with an identifier that specifies the requested information. A requestor can use this information to access that data source directly to retrieve the objects stored there.

In more detail, an extension schema 306 provides the ability to extend the core schema 304 by some application or implementation specific common elements. One or more extension schemas 306 may be defined which have substantially same structure as the core schema 304, but do not have to be used by every output schema 302. The extension schemas 306, together with the core schema 304, define the scope 303 of an application. The scope 303 represents the basic framework within which different information models may be implemented.

In more detail, an output schema 302 describes the data model on which a requesting application: bases its requests (e.g. an output model). It includes a core schema 304 and optionally one or more extension schemas 306 to access the basic elements that make up the scope 303. An output schema 302 specifies a hierarchy that defines the context in which the data elements are represented. The queried results from the repository 20 are formatted based on the specified hierarchy before they are returned to the requestor. Beside the usage of the common elements, an output schema 302 may also introduce new elements that are only specific to that single output model. Such elements are typically levels, which include nested elements, e.g. levels that reflect real database levels or auxiliary levels that do not exist in the real database data model. Other elements may be defined in either the core or the extension schema, 304, 306. One output schema 302 together with the core and the extension schemas 304, 306 make up an information model 305, which describes the semantics of the current data model without referencing anything in the real database. The link between the currently used information model defined by the output schema 302 and the actual representation in the database is defined in a mapping schema 308. An output schema 302 describes a complete hierarchy. A query can narrow a requested depth down or request only certain parts of the output model. The following is the general layout of an output schema 302:
Referencing the core schema 304 and the extension schemas 306 (if necessary)
Defining levels, starting with the lowest level. A higher level refers to the lower level and describes its multiplicity.
Defining the output model, which may either consist of the whole hierarchy (referencing the highest level) or a collection of lower levels, if a query requests the data be displayed starting at a lower level.

In more detail, a mapping schema 308 describes the structure of an XML file, which defines how elements used in the output schema 302 correspond to tables, fields or other entities in the repository 20. An actual XML mapping file 309 maps the data specified in one output schema 302. A different mapping file 309 is needed if another output schema 302 is used in the same scope 303 and this output schema 302 introduces new levels. Otherwise the same mapping file 309 may be used. A mapping file 309 consists of the following primary elements:
Entity—An entity represents an element that is mapped to a whole repository 20 storage resource, e.g. a database table. An entity has “name” and “mapTable” child nodes.
Field—A field represents an atomic element in the repository 20 storage resource, e.g. a field in a table. Respective fields have the child “name”, “mapTable”, “mapField”, “isExtensionField”, “isSearchable” nodes
Auxiliary level—An auxiliary level mirrors an artificial level that is introduced in the output schema 302 to add a new hierarchy level that consists of one or more fields. It functions as a grouping mechanism. An example is a level called “Gender and Disease”, which is used as a first level in an output model. If a requester queries for records of patients with the disease “HIV”, this auxiliary level would cause the results to be formatted in two groups, one with the attributes “male” and “HIV”, the other with the attributes “female” and “HIV”. An auxiliary level has a “name”, and at least one “relation” that describes which fields are involved in that auxiliary level. A level itself can not be part of a query, but the fields associated with the auxiliary level may be.

The children used in the primary elements are:
Name—is the name used for that element in the output schema 302.
MapTable—is the name of the table to which this entity maps or where this field is located.
MapField—is the field in the “mapTable” to which this field maps.
IsExtensionField—indicates whether the field is part of the “mapTable” itself or its extension table.
IsSearchable—indicates whether this field should be included in regular expression (RegExp) searches or not.
Relation—is used in an auxiliary level and describes a field as part of the auxiliary level. The relation consists of “name”, “mapTable”, “mapField”, “isExtensionField”.

Referring in more detail to a query schema 310, an application can submit multiple queries to request data from the data abstraction layer 204. The respective :queries are expressed in an XML file, which conforms to the query schema 310. One query XML file may contain one query at a time. The result of each query is formatted according to the output model, as defined by an output schema 302, regarding the query depth and restrictions. The query may be defined in a standard query language such as SQL or XQuery. In this way a widely known language is used and a requester is not required to learn a new query language. It is possible that not all the possible operators and query elements of a particular query language are supported by the data abstraction layer 204. In such a case, a restricted subset of applicable query operations and relations may be defined. The query language itself is the database independent way of describing a query. Each query Is parsed by the data abstraction layer 204 according to the currently used database in the repository 20.

Referring in more detail to a resource schema 312, possible data sources, which the data abstraction layer 204 or the requester may access in order to retrieve data, are defined in the resource schema 312. A certain resource is specified by its type and its actual connection information. The type describes of what kind the data source is, e.g. “PACS”. There may be one or more instances of a type. Each instance describes an actual connection to a data source of that type. In the resource schema 312, the possible types are defined. A resource XML file 313, which adheres to the resource schema 312 is as follows:
“Resource” element as root
   Type—Multiple elements, describing a type, e.g. “PACS”
      § Instance—Multiple elements, specifying an instance of a resource of the surrounding type, which provides the information how to connect to that data source. The structure of the instance element depends on the type of the resource.

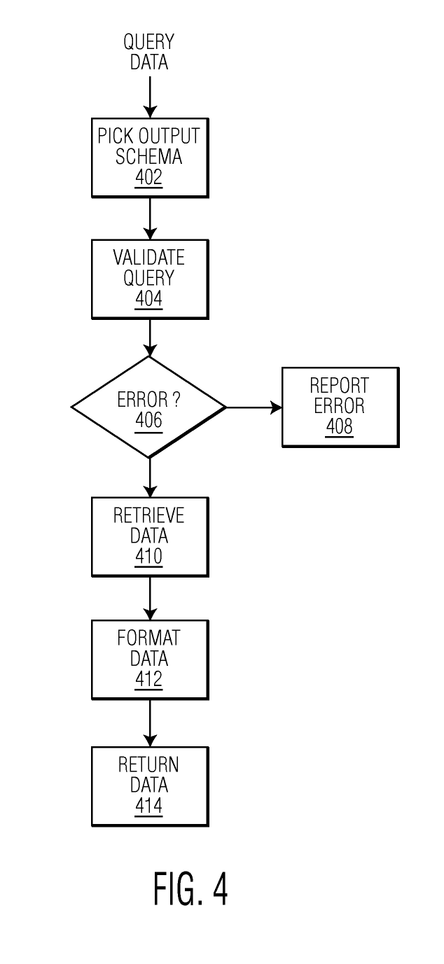

FIG. 4 is a flowchart illustrating the operation of a system for adaptively querying a data storage repository according to principles of the present invention. Referring concurrently to FIG. 2 FIG. 3, and FIG. 4, XML format query data 202 is received by the data abstraction component 204. Before the operation of the system as illustrated in FIG. 4, the schema and files illustrated in FIG. 3 have been populated and verified.

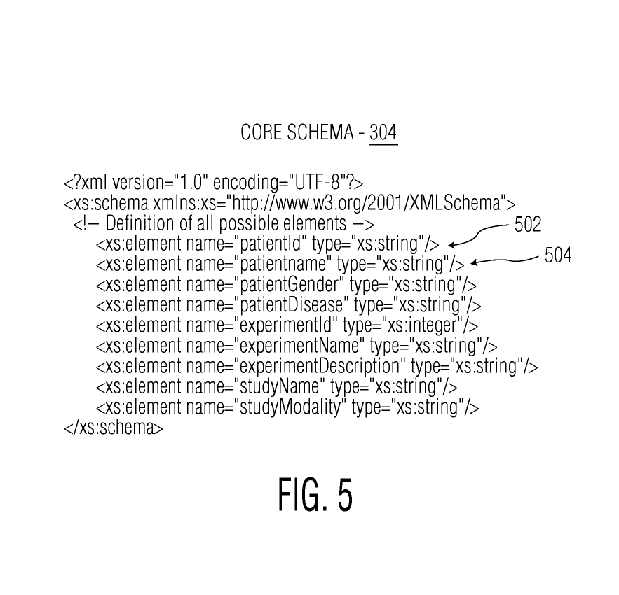

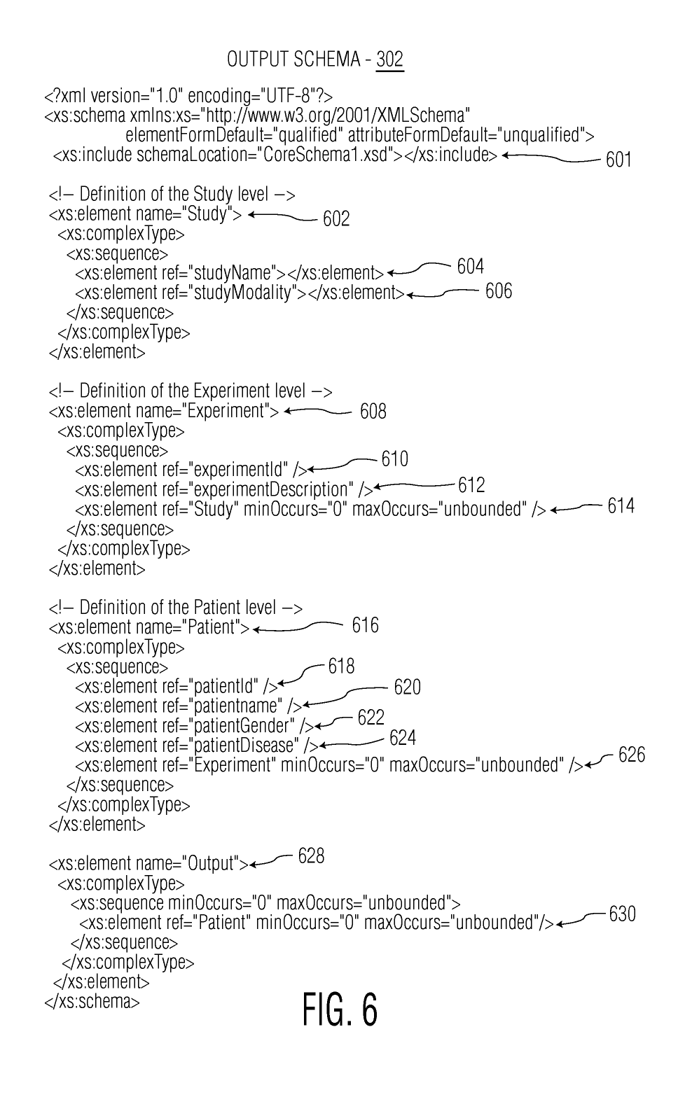

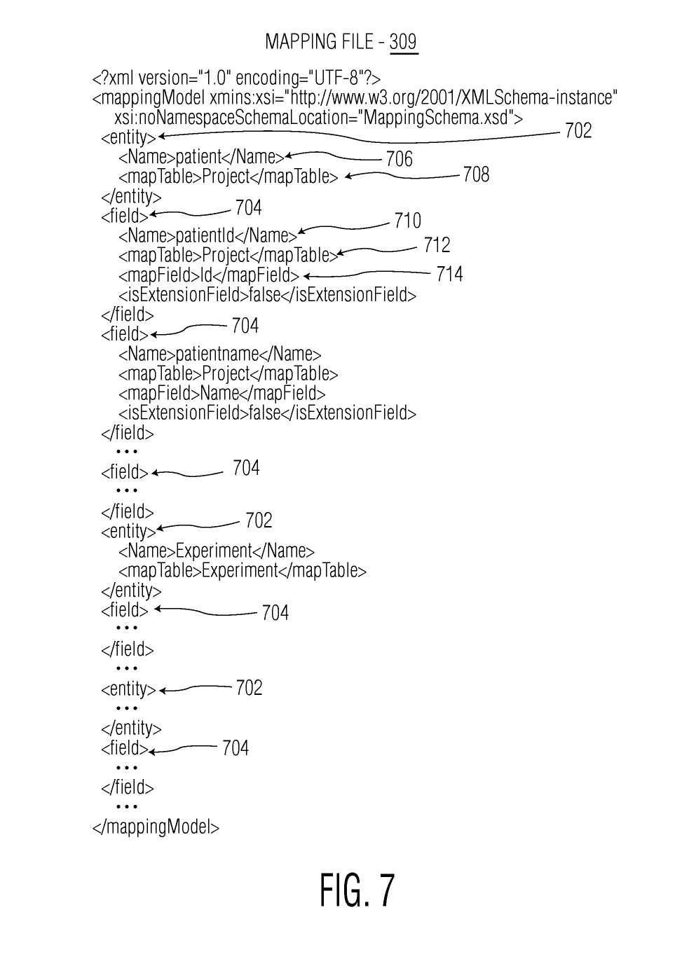

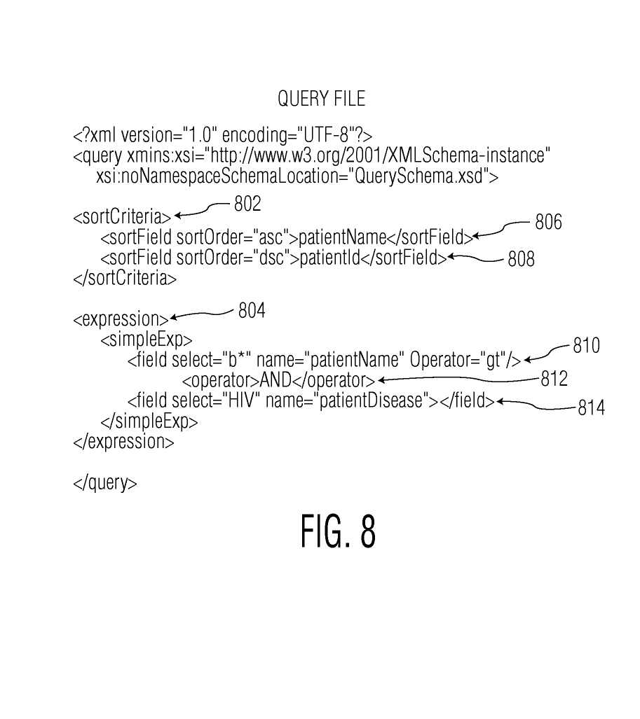

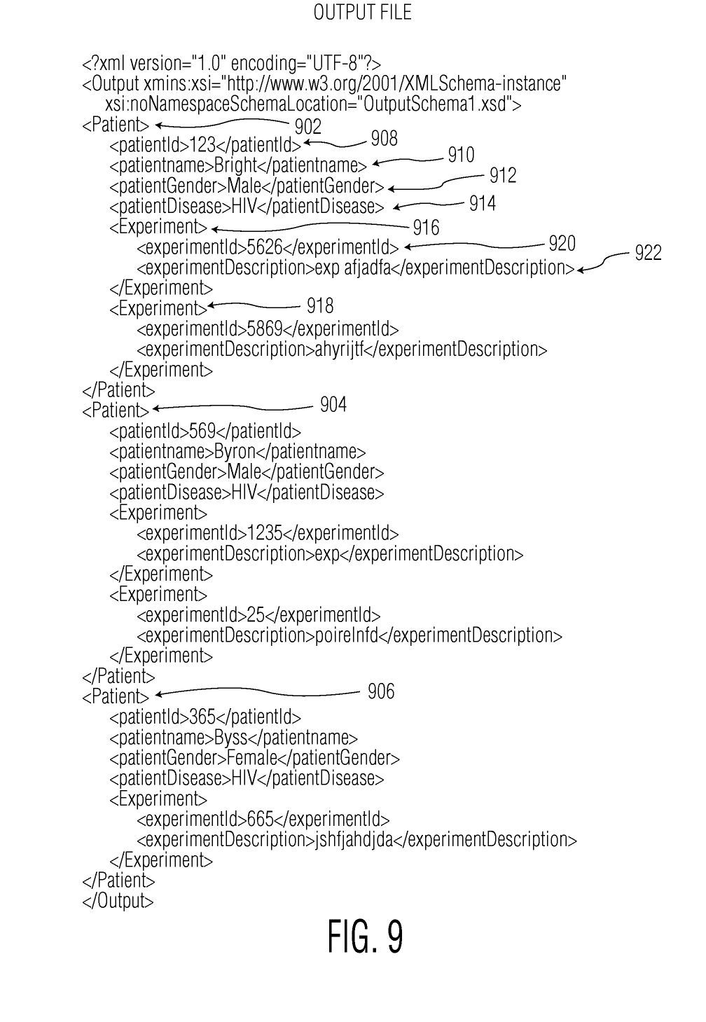

FIG. 5 is an example of a core schema, FIG. 6 is an example of an output schema, FIG. 7 is an example of a mapping file, FIG. 8 is an example of a query file, and FIG. 9 is an example of a output file. These files are useful in understanding the operation of the system as illustrated in FIG. 4. A more detailed description of these schema and files, and more detailed examples of them, are given in the Appendix, following.

Referring to FIG. 5, a core schema 304 defines a plurality of data elements which are made available to requesters. The data elements are defined by a name and data type. For example, a first data element 502 has a name “patientId” and a type of “string”; a second data element 504 has a name “patientname” and a type of “string”; and so forth.

Referring to FIG. 6, the output schema 302 defines a plurality of levels of reporting in which data elements defined in the core schema 304 may be arranged. As described above, the output schema 302 includes the core schema 304 (FIG. 5) in order to have access to the data elements defined in the core schema 304. An include element 601 provides the reference to the core schema 304, specified by the file name “CoreSchema1.xsd”.

In FIG. 6, a first level has the name “Study” 602, and includes the data elements “studyName” 604 and “studyModality” 606. A second level has the name “Experiment” 608 and includes the data elements “experimentID” 610 and “experimentDescription” 612, and further includes zero or more results of the “Study” level 614. A third level has the name “Patient” 616 and includes the data elements “patientID” 618, “patientname” 620, “patientGender” 622 and “patientDisease” 624, and further includes zero or more results of the “Experiment” level 626. The actual output file defined by the output schema 302 of FIG. 6 has the name “Output” 628 and includes zero or more results of the “Patient” level 630.

FIG. 7 is an example of a mapping file 309. The mapping file includes <entity> entries 702 and <field entries> 704. As described in more detail in the Appendix, the <entity> entries 702 define a table which is available to the requester and the field entries 704 define fields in the table. The entries in the mapping file 309 provide a correspondence between the names of tables and fields used by the requester and those used by the repository 20 (FIG. 1). In FIG. 7, a first <entity> entry 706 has the name “Patient”, which is the name used by the requester. Associated with this name is a mapTable “Project” 708, which is the name used in the repository 20. Further entries define fields. A first field has a name “patientID” 710, which is the name used by the requester. The “patientID” field is in the mapTable named “Project” 712 and the field in the “Project” table corresponding to the “patientID” field is named “Id” 714. Other entities and fields are defined in the mapping file 309 in a similar manner.

With the core schema 304, output schema 302, and mapping file 309 defined, the adaptive query system operates as illustrated in FIG. 4. Query data is received by step 402. The query data is in the form of an XML file which is assembled according to the query schema 310 (FIG. 3). The query schema 310 is illustrated in the Appendix and defines the structure of the query file. How to construct such a query file according to a query schema is known to one skilled in the art, is not germane to the present invention, and is not described in detail here.

FIG. 8 illustrates such a query file. In FIG. 8, sort criteria 802 and searching parameters 804 are defined. In FIG. 8, the sort criteria 802 are to first sort on the data field “patientName” in ascending order 806 and then to sort on the data field “patientID” in descending order 808. A first search criterion is to select those records for which the “patientname” data field starts with the letter “B” and beyond (810) and (812) for which the “patientDisease” data field is “HIV”.

In step 402 an output schema 302 (FIG. 6), is selected which corresponds to the a query file (FIG. 8) received by the data abstraction component 204 and provides data in a format desired by the requester. This output schema 302 will be used to control the formatting of the data returned to the requester. In step 404, the contents of the query file is validated against the query XML schema 310 (see Appendix) to verify that it is in the proper format to be properly processed. The contents of the query file is further validated against the core schema 304 (FIG. 5), extension schema 306 (not used in this example) and output schema 302 (FIG. 6) to verify that it requests data elements which are available to be accessed. If properly validated, the query file may be parsed to extract the data elements which are deemed available by the core schema 304 and extension schema 306 in the scope 303 of the application. In step 406, if the received XML query data file is properly verified then processing continues in step 410, otherwise the error is reported to the requester 408.

In step 410, the data in the mapping file 309 (FIG. 7), constructed according to the mapping schema 308 (FIG. 3), is accessed to generate a second query to retrieve data elements from a first storage data structure in the repository 20. As described above, this mapping file 309 determines the names and locations of the stored data elements in the repository 20 (FIG. 1) corresponding to the data elements defined in the information model 305 and requested by the query 202 (FIG. 2). That is, the tables and field names corresponding to the data elements requested by the requester are derived from the mapping file 309. A second query is generated to retrieve the requested data from the data repository 20. Also as described above, the second query is in a format compatible with the repository 20, e.g. SQL or Xquery.

Although not shown in the present example, the data abstraction component 204 (FIG. 2) further accesses data in the resource file 313 (FIG. 3) to determine if requested data exists in an external data source (not shown). If so, then the data from the resource file 313 may be used by the data abstraction component 204 to generate a query of the external data source in a format compatible with that data source to retrieve the requested data from the external data source. Alternatively, data may be returned to the requester permitting the requester to access the external data source to retrieve the requested data.

The data elements retrieved from the repository 20 are typically in a different format from that requested by the first query. In step 412, when the requested data has been retrieved from the repository 20 (i.e. a database and/or external data source), the data abstraction component 204 (FIG. 2) accesses data in the output schema and uses that data to format the data acquired from the repository 20 (FIG. 1) into a format compatible with the corresponding first query message. In the present example, the output schema 302 (FIG. 6) is used to format the data retrieved from the repository 20.

In FIG. 9, an output file formatted according to the output schema 302 (FIG. 6) contains results for three patients, 902, 904 and 906. Data for the patients include the “patientID” 908, “patientname” 910, “patientGender” 912 and “patientDisease” 914 data fields, as defined by the patient level 616. For the first patient 902, these fields contain “123”, “Bright”, “Male” and “HIV” respectively. As specified in the query file (FIG. 8), patients with names beginning with “B” or higher (810) and (812) with disease “HIV” 814 are listed. The patient 902, 904, 906 data further includes experiment data. For patient 902, data on two experiments 916 and 918 are returned. For example, the experiment 916 include the “experimentID” 920 and “experimentDescription” 922 data fields, as defined by the experiment level 608 (FIG. 6). No studies were associated with these experiments. If they had been then the data fields associated with the studies, as defined by the study level 602 would have been included in the output file within the associated experiment listing.

In step 414, the retrieved data (FIG. 9), in the output format requested by the first query, is returned to the requester.

In a system as illustrated in FIG. 1, changes may be introduced into the adaptive query system by changing the schemas (302-312 of FIG. 3) and corresponding files (309, 313) without re-compiling and/or re-testing the executable code of either the requesting executable application or the data abstraction component 214 used in performing the activities. Such changes include: (a) adding or changing data elements returned to a requester; (b) changing the relationship among the data elements returned to a requester; (c) changing the data elements and/or relationship of data elements in the repository 20; (d) changing the repository 20; and/or (e) any other change related to storage and retrieval of data in response to queries from executable applications and components or clients.

What is claimed is:

1. A system for adaptively querying a data storage repository, comprising:
an input processor for receiving a plurality of different first query messages in a corresponding plurality of different formats;
a repository of stored data elements in a first storage data structure; and
an intermediary processor for automatically performing the activities of:
parsing said plurality of first query messages to identify requested data elements,
mapping said identified requested data elements to stored data elements in said first storage data structure of said repository,
generating a plurality of second query messages in a format compatible with said repository for acquiring said stored data elements,
acquiring said stored data elements from said repository using said generated plurality of second query messages, and
processing said stored data elements acquired in response to said plurality of second query messages for output in a format compatible with said corresponding plurality of different formats of said first query messages.

2. A system according to claim 1, wherein said intermediary processor automatically performs said activities by embodying information related to said activities in at least one file comprising data describing details related to performing said activities.

3. A system according to claim 2, wherein said at least one file comprises a core schema file comprising data defining said requested data elements.

4. A system according to claim 3, wherein said core schema file comprises data defining respective names of said requested data elements.

5. A system according to claim 3, wherein said at least one file comprises a extension schema file comprising data defining further requested data elements.

6. A system according to claim 5, wherein said extension schema file comprises data defining respective names of said requested data elements.

7. A system according to claim 2, wherein said at least one file comprises an output schema file comprising data specifying respective relationships among said requested data elements.

8. A system according to claim 2, wherein said output schema file comprises data defining an output hierarchy.

9. A system according to claim 8, wherein said output schema file comprises data defining requested data elements.

10. A system according to claim 9 wherein said output schema file comprises data defining levels, said level defining data comprising data defining requested data elements and data defining requested data defined in other levels.

11. A system according to claim 2, wherein said at least one file comprises a mapping file comprising data specifying the correspondence among requested data elements and data elements in the storage data structure in the repository.

12. A system according to claim 11, wherein said mapping file comprises data relating a requested data element to a table in said storage data structure in said repository, and data relating said requested data element to a field in said table in said storage data structure in said repository.

13. A system according to claim 2, wherein said at least one file comprises a resource file comprising data specifying external data sources in said repository.

14. A system according to claim 13, wherein said resource file comprises data for accessing said external source.

15. A system according to claim 14 wherein said data for accessing said external source is output is a format compatible with said corresponding plurality of different formats of said first query messages.

16. A system according to claim 2, wherein said at least one file comprises a query schema file comprising data defining the respective content and structure of said first query messages.

17. A system according to claim 16, wherein said at least one file comprises a query file comprising data defining said first query messages.

18. A system according to claim 1, wherein said intermediary processor automatically performs said activities without re-compiling executable code used in performing said activities.

19. A system according to claim 1, wherein said intermediary processor automatically performs said activities without re-testing executable code used in performing said activities.

20. A system according to claim 1, wherein:
said first query messages comprise query files conforming to a query schema; and
said second query messages comprise queries executable by said repository.

21. A system according to claim 1, wherein said first query messages are in a format determined by a query schema and comprising at least one of, (a) SQL compatible query format and (b) XQuery compatible query format.

22. A system according to claim 7, wherein said query schema determines at least one of, (a) query search depth of hierarchical data elements in said repository and (b) restrictions on searching said repository.

23. A system according to claim 1, wherein said format compatible with said corresponding plurality of different formats of said first query messages are determined by an output schema.

24. A system according to claim 1, further comprising data determining a core schema indicating data fields accessible in said first storage data structure in said repository of stored data elements.

25. A system according to claim 1, further comprising a mapping schema determining said mapping of said identified requested data elements to said stored data elements in said first storage data structure of said repository.

26. A system for adaptively querying a data storage repository, comprising:
an input processor for receiving at least one first query message comprising a request for information and an instruction determining a data format for providing said information, said instruction being alterable to adaptively change said information and said data format for providing said information;
a repository of stored data elements in a first storage data structure; and
an intermediary processor for automatically performing the activities of:
parsing said at least one first query message to identify requested data elements,
mapping said identified requested data elements to stored data elements in said first storage data structure of said repository,
generating at least one second query message in a format compatible with said repository for acquiring said stored data elements,
acquiring said stored data elements from said repository using said generated at least second query messages, and
processing said stored data elements acquired in response to said at least one second query message for output in a format compatible with said data format determined by said instruction in said at least one first query message.

27. A system according to claim 10, wherein said instruction determining said data format for providing said information comprises a markup language output schema.

28. A system according to claim 10, wherein said markup language output schema is an XML schema.
